(19) United States
(12) Patent Application Publication
(10) Pub. No.: US 2004/0146614 A1
(43) Pub. Date: Jul. 29, 2004

(54) Antimicrobial preservation systems for foodstuffs

(76) Inventors: Peter Ottersbach, Windeck (DE); Beate Kossmann, Hagen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/473,996

(22) PCT Filed: Feb. 21, 2002
(86) PCT No.: PCT/EP02/01815

(30) Foreign Application Priority Data
Apr. 6, 2001 (DE) 101 17 106.4

(51) Int. Cl. A23G 1/00

(52) U.S. Cl. 426/133

(57) ABSTRACT

The invention relates to microbecidal films using antimicrobial polymers, their preparation and use.

The invention relates to the implementation and use of antimicrobial polymers for producing antimicrobial preservative systems for foods such as packaging films.

More than 90% of all food poisonings are of microbial origin. Among the foods particularly at risk are milk and milk products, cheese, meat and meat-containing products, poultry and poultry-containing products, fish, fish-containing products and mollusks, cakes, puddings and icecream, mayonnaises, sauces and salads and products containing eggs in general. In Germany alone, in the period from 1993 to 1998, more than 35% of all the cases of infection were due to food consumption at home, 22% to that in schools and kindergartens, and 14% to that in restaurants and hotels. In comparison, however, more than 33% of microbial contaminations are due to food manufacture or processing, followed by about 7% contaminations which are due to the producer. Bearing in mind at the same time the large unknown area of more than 43% of cases where determination of the source of contamination did not succeed, it is evident that for optimization with regard to limiting contamination, food manufacture and processing offers the greatest potential. Frequently, also, it is not the microbes themselves, as in the case of pathogenic microorganisms which are the causative agents of disease, but rather toxins which can have a high toxic potential even in the absence of the microbes.

Conventional prophylactic measures are principally based on sterilizing the foods immediately, where possible in individual cases, and then packaging them under sterile conditions or at least ensuring sterile processing and packaging of the foods. Since complete and comprehensive sterile processing is an exalted aim, but an aim only achievable approximately in practice, however, despite all efforts described there is still a significant residual risk which, depending on the respective product and environmental conditions, for example temperature and moisture, varies in its seriousness.

The direct use of biocides in foods is obviously subject to severe limitations, since conventional biocides themselves have toxic potential which would frequently be unacceptable as a residue in the food product. There is therefore a requirement for novel active compounds which firstly have sufficient activity against microbial contamination in the food sector, but secondly, in use, do not pass over to the food.

Antimicrobial polymers are known from the sanitation field. For instance, European Patent Application 0 862 858 discloses the copolymers of tert-butylaminoethyl methacrylate, a methacrylic ester containing a secondary amino function, has inherently microbicidal properties. The antimicrobial activity of these polymeric systems is closely associated with their three-dimensional structure, conformation and available surface area. They are especially suitable in fields of application where long-lasting, surface-active protection against microbial attack is important. These copolymers are prepared by graft polymerization of tert-butylaminoethyl methacrylate to a polymer surface. When grafting is performed, residual monomers can remain on the surface, which can thus be eluted. This cannot be tolerated in the food sector; purification methods for removing the residual monomer are too complex.

In addition, a large number of contact-microbicidal polymers are disclosed by the following Patent Applications: DE 100 24 270, DE 100 22 406, PCT/EP00/06501, DE 100 14 726, DE 100 08 177, PCT/EP00/06812, PCT/EP00/06487, PCT/EP00/06506, PCT/EP00/02813, PCT/EP00/02819, PCT/EP00/02818, PCT/EP00/02780, PCT/EP00/02781, PCT/EP00/02783, PCT/EP00/02782, PCT/EP00/02799, PCT/EP00/02798, PCT/EP00/00545, PCT/EP00/00544.

These polymers do not contain low-molecular-weight constituents; the antimicrobial properties are due to the contact of bacteria with the surface.

Polymers which have contact-microbicidal activity without the use of low-molecular-weight biocides are called hereinafter antimicrobial polymers.

Use of these polymers or coating methods is not known in the food sector.

It is therefore an object underlying the present invention to develop novel preservative systems for food processing or food packaging, which systems meet the requirements described of a preservative or packaging system applicable in the food sector.

It has surprisingly been found that the object described is achieved by using antimicrobial polymers for preparing antimicrobial packaging, in particular films.

The usability of the antimicrobial systems described for preserving foods by contact-microbicidal activity was unforeseeable, since the requirements in the food sector are particularly high.

It was necessary to note that the microorganisms can not only already be present in the food and their proliferation is to be at least arrested, but also new microbial contamination due to additional bacteria introduced afterwards, for example during processing, storage or sale, is to be avoided.

The antimicrobial polymer, for coating or blend formation, is either immediately incorporated during the production of the packaging or films, for example during extrusion or film blowing, or else used subsequently in the form of a coating, for example as part of a coating or resin, or else as a further film, applied to this. This produces as a result an antimicrobial polymer-impregnated surface.

The surfaces thus treated exhibit antimicrobial activity which is long-lasting and resistant to environmental effects and physical stresses. These coatings do not contain low-molecular-weight biocides, which effectively excludes migration of toxicologically problematic substances over the entire period of service.

The present invention therefore relates to antimicrobial films comprising antimicrobial polymers. The antimicrobial polymers used in the antimicrobial films can be, for example, those in the abovementioned patent applications; preferably the antimicrobial polymers are prepared from nitrogen- and/or phosphorus-functionalized monomers.

Particularly suitable antimicrobial polymers are prepared from at least one of the following monomers:

2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethyl-aminoethyl acrylate, 2-dimethylaminoethyl acrylate, dimethylaminopropylmethacrylamide, diethylaminopropylmethacrylamide, 3-dimethylaminopropylacrylamide, 2-methacryloyloxy-ethyltrimethylammonium ethosulfate, 2-diethylaminoethyl methacrylate, 2-methacryloyloxy-ethyltrimethylammonium chloride, 3-methacryloylaminopropyltrimethylammonium chloride, 2-methacryloyloxyethyltrimethylammonium chloride, 2-acryloyloxyethyl-4-benzoyldi-methylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaminoethyl vinyl ether and/or 3-aminopropyl vinyl ether.

The inventive antimicrobial films can either be prepared completely from the antimicrobial polymers, or contain, however, at least 0.1 to 70% by weight, particularly 2 to 50% by weight, particularly preferably 5 to 25% by weight of this polymer.

It is therefore possible that the antimicrobial films are prepared from a copolymer of said monomers together with a further olefinically unsaturated monomer, or consist of a polymer blend of at least one antimicrobial polymer and at least one further, preferably non-antimicrobial, polymer.

Further olefinically unsaturated monomers are, for example, acrylates or methacrylates, such as MMA, BMA, acrylic acid, styrene, vinyl chloride, acrylamides, acrylonitriles, olefins, allyl compounds, vinyl ketones, vinyl acidic acid, vinyl acetate, vinyl ester, ethyl methacrylate, tert-butyl methacrylate, vinyl ether, ethylene and propylene.

As further polymers, that is to say non-antimicrobial polymers, in principle all macromolecules customarily used for producing films can be used, in particular PVC, polystyrene, polyamides, polyethylene, polypropylene, polymethacrylates, polysulfones, polyacylonitrile, polyterephthalates (PETs), polycarbonates, polyurethane, cellulose, cellulose acetate or further cellulose derivatives. Cellulose derivatives have the advantage that no micro domain formation is to be expected with the frequently also hydrophilic antimicrobial polymers, which facilitates uniform surface availability of the antimicrobial polymers.

In addition, the inventive films can consist of a previously produced film comprising a non-antimicrobial polymer which has been coated with at least one antimicrobial polymer. The non-antimicrobial polymer films can consist of said polymers.

If antimicrobial films are coated in this manner, the coating can be applied to one side or to both sides of the non-antimicrobial film.

Furthermore, the inventive films can be produced by in-situ film formation on any supports which are of importance in food processing, for example, metal, glass, ceramics. For this a solution which comprises the antimicrobial polymer and if appropriate a further film formation is applied immediately to a support. After evaporating the solvent, this produces a surface finished with an inventive film.

The inventive films preferably have a thickness of 0.01 to 1.0 mm, preferably 0.1 to 0.5 mm. The inventive films are produced in a customary manner per se, for example by extrusion, film-blowing, calendering, laminating, rolling or by evaporating solutions of the antimicrobial polymer or polymer blend (“Kunststoffkompendium”, A. Franck, K. Biederbick—Vogel Buchverlag, 3rd Edition, pp. 81 ff.).

The present invention further relates to the use of the antimicrobial films in the food sector. Here, mention may be made, in particular, of the use as packaging film, whether it be direct, for example as packaging for meat and sausage goods, or as a tube, for example for milk, drinking water or wine, or as packaging film as a part of a packaging system which consists of a plurality of layers, for example cartons for packaging milk or fruit juices.

The inventive films can also be used for lining or coating food packaging or food containers; here, examples which may be mentioned are bottles made of plastics such as PET, or large containers such as barrels, tank trunks or silos.

The inventive films can also be used for lining or coating articles other than containers for foods, thus, they can serve for the inner lining of pipes or tubes for transporting liquid or pumpable foods. Foods of this type are all foods which are liquid per se, such as milk, beer or wine, and all foods occurring in pumpable form, for example ketchup, or foods occurring in suspension, for example animal feed.

The present invention therefore further relates to apparatuses for sterilizing liquid or pumpable foods, the apparatuses having contact surfaces which are coated or lined with antimicrobial films. Contact surfaces which serve here are, in particular, pipes, tubes, mixers, sieves, holders, container surfaces, machine parts or other surfaces which foods are moved past.

For a further description of the present invention, the following examples are given which describe the invention in more detail but are not to limit its scope as given in the patent claims.

### EXAMPLE 1

50 ml of dimethylaminopropylmethacrylamide (Aldrich) and 250 ml of ethanol are placed in a three-neck flask and heated to 65° C. under an argon stream. Then, 0.5 g of azobisisobutyronitrile, dissolved in 20 ml of ethanol, are added dropwise slowly with stirring. The mixture is heated to 70° C. and stirred at this temperature for 6 hours. After the end of this time the solvent is removed from the reaction mixture by distillation and the remainder is dried in vacuo at 50° C. for 24 hours. The product is then dissolved in 200 ml of acetone, then the solvent is removed from the reaction mixture by distillation and the remainder is dried in vacuo at 50° C. for 24 hours. The reaction product is then finely ground.

### EXAMPLE 1a

50 g of polypropylene are heated to 180° C. and intimately mixed with 3 g of the product from example 1. The still-hot polymer mixture is processed with a laboratory calender so that a plastic film approximately 100 micrometers thick forms.

### EXAMPLE 1b

A 3×3 cm-size piece of the film from example 1a is fixed to the bottom of a glass beaker which contains 10 ml of a test microorganism suspension of Pseudomonas aeruginosa. The system thus prepared is then shaken for a period of 4 hours. 1 ml of the test microorganism suspension is then removed. After the end of this time the microbial count has decreased from 10⁷ to 10² microorganisms per ml.

### EXAMPLE 1c

A 3×3 cm-size piece of the film from example 1a is fixed to the bottom of glass beaker which contains 10 ml of a test microorganism suspension of Staphylococcus aeruginosa. The system thus prepared is then shaken for a period of 4 hours. 1 ml of the test microorganism suspension is then taken off. After the end of this time the microorganism count has decreased from 10⁷ to less than 10² microorganisms per ml.

### EXAMPLE 2

50 ml of tert-butylaminoethyl methacrylate (Aldrich) and 250 ml of ethanol are placed in a three-neck flask and heated to 65° C. under an argon stream. Then, 0.5 g of azobisisobutyronitrile, dissolved in 20 ml of ethanol, are added dropwise slowly with stirring. The mixture is heated to 70° C. and stirred at this temperature for 6 hours. At the end of this time the solvent is removed from the reaction mixture by distillation. The product is then dried in vacuo at 50° C. for 24 hours. The product is then dissolved in 200 ml of acetone, and then the solvent is removed from the reaction mixture by distillation and the remainder is dried in vacuo at 50° C. for 24 hours.

### EXAMPLE 2a

50 g of polypropylene are heated to 180° C. and intimately mixed with 3 g of the product from example 2. The still-hot polymer mixture is processed with a laboratory calendar so that a plastic film approximately 100 micrometers thick forms.

### EXAMPLE 2b

A 3×3 cm-size piece of the film from example 2a is fixed to the bottom of a glass beaker which contains 10 ml of a test microorganism suspension of Pseudomonas aeruginosa. The system thus prepared is then shaken for a period of 4 hours. 1 ml of the test microorganism suspension is then taken off. At the end of this time, Pseudomonas aeruginosa cells are no longer detectable.

### EXAMPLE 2c

A 3×3 cm-size piece of the film from example 2a is fixed to the bottom of a glass beaker which contains 10 ml of a test microorganism suspension of Staphylococcus aeruginosa. The system thus prepared is then shaken for a period of 4 hours. 1 ml of the test microorganism suspension is then taken off At the end of this time the microorganism count has decreased from 10⁷ to less than 10² microorganisms per ml.

### EXAMPLE 3

50 ml of tert-butylaminoethyl methacrylate (Aldrich) and 250 ml of ethanol are placed in a three-neck flask and heated to 65° C. under an argon stream. Then, 0.6 g of azobisisobutyronitrile dissolved in 20 ml of ethyl methyl ketone are added dropwise slowly with stirring. The mixture is heated to 70° C. and stirred at this temperature for 72 h. At the end of this time the reaction mixture is stirred into 1.5 l of deionized water, the polymeric product precipitating out. After filtering off the product, the filter residue is washed with 100 ml of a mixture of ethanol/deionized water in a ratio of 1:1 to remove any residual monomer still present. The product is then dried in vacuo at 50° C. for 24 hours. 2 g of the product are dissolved in 10 g of ethanol and applied to a 4×6 cm-size polyethylene film using a 100 micrometer doctor blade. The film is then dried at 50° C. for 24 hours.

### EXAMPLE 3a

2 g of the product from example 3 are dissolved in 10 g of ethanol and applied to a 4×6 cm-size polyethylene film using a 100 micrometer doctor blade. The film is then dried at 50° C. for 24 hours.

### EXAMPLE 3b

A 3×3 cm-size piece of the film from example 3a is fixed to the bottom of a glass beaker which contains 10 ml of a test microorganism suspension of Pseudomonas aeruginosa. The system thus prepared is then shaken for a period of 4 hours. 1 ml of the test microorganism suspension is then taken off. At the end of this time the microorganism count has decreased from 10⁷ to 10² microorganisms per ml.

### EXAMPLE 3c

A 3×3 cm-size piece of the film from example 3a is fixed to the bottom of a glass beaker which contains 10 ml of test microorganism suspension of Staphylococcus aeruginosa. The system thus prepared is then shaken for a period of 4 hours. 1 ml of the test microorganism suspension is then taken off. At the end of this time the microorganism count has decreased from 10⁷ to less than 10² microorganisms per ml.

### EXAMPLE 3d

2 g of the product from example 3 are dissolved in 10 g of ethanol and applied to a 4×6 cm-size silicone film using a 100 micrometer doctor blade. The film is then dried at 50° C. for 24 hours.

### EXAMPLE 3e

A 3×3 cm-size piece of the film from example 3d is fixed to the bottom of a glass beaker which contains 10 ml of a test microorganism suspension of Pseudomonas aeruginosa. The system thus prepared is then shaken for a period of 4 hours. 1 ml of the test microorganism suspension is then taken off. At the end of this time the microorganism count has decreased from 10⁷ to 10² microorganisms per ml.

### EXAMPLE 3f

A 3×3 cm-size piece of the film from example 3d is fixed to the bottom of a glass beaker which contains 10 ml of a test microorganism suspension of Staphylococcus aeruginosa. The system thus prepared is then shaken for a period of 4 hours. 1 ml of the test microorganism suspension is then taken off. At the end of this time the microorganism count has decreased from 10⁷ to less than 10² microorganisms per ml.

### EXAMPLE 4

90 ml of 2-tert-butylaminoethyl methacrylate (Aldrich) and 180 ml of ethanol are placed in a three-neck flask and heated to 65° C. under an argon stream. Then, 0.745 g of azobisisobutyronitrile dissolved in 20 ml of ethyl methyl ketone are added dropwise slowly with stirring. The mixture is heated to 70° C. and stirred at this temperature for 72 hours. At the end of this time the reaction mixture is stirred into 1 l of deminerealized water, the polymeric product precipitating out. After filtering off the product the filter residue is washed with 100 ml of a 10% strength solution of ethanol in water to remove residual monomer still present. The product is then dried in vacuo at 50° C. for 24 hours. 4 g of the product are dissolved in 32 g of diisononyl phthalate. 64 g of polyvinyl chloride granules are then added to this mixture, the mixture being intimately stirred until it becomes pasty. 20 g of the resultant paste are spread onto a metal plate using a doctor blade so that a layer thickness of 0.7 mm thickness is established. The plate with the accompanying paste is then heated to 200° C. for 2 minutes, the paste gelling and a soft PVC film being formed.

### EXAMPLE 4a

A 3×3 cm-size piece of the film from example 4 is fixed to the bottom of a glass beaker which contains 10 ml of a test microorganism suspension of Pseudomonas aeruginosa. The system thus prepared is then shaken for a period of 4 hours. 1 ml of the test microorganism suspension is then taken off. At the end of this time the microorganism count has decreased from 10⁷ to 10² microorganisms per ml.

### EXAMPLE 4b

A 3×3 cm-size piece of the film from example 4 is fixed to the bottom of a glass beaker which contains 10 ml of a test microorganism suspension of Staphylococcus aeruginosa. The system thus prepared is then shaken for a period of 4 hours. 1 ml of the test microorganism suspension is then taken off. At the end of this time the microorganism count had decreased from 10⁷ to less than 10² microorganisms per ml.

### EXAMPLE 5

50 ml of tert-butylaminoethyl methacrylate (Aldrich) and 250 ml of ethanol are placed in a three-neck flask and heated to 65° C. under an argon stream. Then, 0.6 g of azobisisobutyronitrile dissolved in 20 ml of ethyl methyl ketone are added dropwise slowly with stirring. The mixture is heated to 70° C. and stirred at this temperature for 72 hours. At the end of this time the reaction mixture is stirred into 1.5 l of deionized water, the polymeric product precipitating out. After filtering off the product, the filter residue is washed with 100 ml of a mixture of ethanol/deionized water in a ratio of 1:1 to remove any residual monomer product present. The product is then dried in vacuo at 50° C. for 24 hours. 30 g of the are then compounded with 1 000 g of PVC granules. The compound is then extruded using a laboratory extruder to form a 4 cm-wide film.

### EXAMPLE 5a

A 3×3 cm-size piece of the film from example 5 is fixed to the bottom of a glass beaker which contains 10 ml of a test microorganism suspension of Pseudomonas aeruginosa. The system thus prepared is then shaken for a period of 4 hours. Then 1 ml of the test microorganism suspension is taken off. At the end of this time the microorganism count has decreased from 10⁷ to 10² microorganisms per ml.

### EXAMPLE 5b

A 3×3 cm-size piece of the film from example 5 is fixed to the bottom of a glass beaker which contains 10 ml of a test microorganism suspension of Staphylococcus aeruginosa. The system thus prepared is then shaken for a period of 4 hours. 1 ml of the test microorganism suspension is then taken off. At the end of this time the microorganism count has decreased from 10⁷ to less than 10² mircoorganisms per ml.

### EXAMPLE 6

30 ml of tert-butylaminoethyl methacrylate (Aldrich), 20 ml of methyl methacrylate (Aldrich) and 250 ml of ethanol are placed in a three-neck flask and heated to 65° C. under an argon stream. Then, 0.6 g of azobisisobutyronitrile dissolved in 20 ml of ethyl methyl ketone are added dropwise slowly with stirring. The mixture is heated to 70° C. and stirred at this temperature for 72 h. At the end of this time the reaction mixture is stirred into 1.5 l of deionized water, the polymeric product precipitating out. After the product is filtered off, the filter residue is washed with 100 ml of a mixture of ethanol/deionized water in a ratio of 1:1 to remove any residual monomer present. The product is then dried in vacuo at 50° C. for 24 hours. 2 g of the product are dissolved in 10 g of ethanol and applied to a 4×6 cm-size polyethylene film using a 100 micrometer doctor blade. The film is then dried at 50° C. for 24 hours.

### EXAMPLE 6a

2 g of the product from example 6 are dissolved in 10 g of ethanol and applied to a 4×6 cm-size polyethylene film using a 100 micrometer doctor blade. The film is then dried at 50° C. for 24 hours.

### EXAMPLE 6b

A 3×3 cm-size piece of the film from example 6a is fixed to the bottom of a glass beaker which contains 10 ml of a test microorganism suspension of Pseudomonas aeruginosa. The system thus prepared is then shaken for a period of 4 hours. 1 ml of the test microorganism suspension is then taken off. At the end of this time the microorganism count has decreased from 10⁷ to 10² microorganisms per ml.

### EXAMPLE 6c

A 3×3 cm-size piece of the film from example 6a is fixed to the bottom of a glass beaker which contains 10 ml of a test microorganism suspension of Staphylococcus aeruginosa. The system thus prepared is then shaken for a period of 4 hours. 1 ml of the test microorganism suspension is then taken off. At the end of this time the microorganism count has decreased from 10⁷ to less than 10² microorganisms per ml.

1. An antimicrobial film comprising antimicrobial polymers.

2. The antimicrobial film as claimed in claim 1, wherein the film consists of a polymer blend of at least one antimicrobial polymer and at least one further polymer.

3. The antimicrobial film as claimed in claim 1, wherein the film consists of a non-antimicrobial polymer film which is coated with at least one antimicrobial polymer.

4. The antimicrobial film as claimed in claims 1 to 3 wherein the films comprise 0.1 to 70% by weight of the antimicrobial polymer.

5. The antimicrobial film as claimed in one of claims 1 to 4, wherein the antimicrobial polymers are prepared from nitrogen- and/or phosphorus-functionalized monomers.

6. The antimicrobial film as claimed in one of claims 1 to 5, wherein the antimicrobial polymers were prepared from at least one of the following monomers:
2-tert-butylaminoethyl methacrylate, 2-diethylaminoethyl methacrylate, 2-diethylaminomethyl methacrylate, 2-tert-butylaminoethyl acrylate, 3-dimethylaminopropyl acrylate, 2-diethylaminoethyl acrylate, 2-dimethylaminoethyl acrylate, dimethylaminopropylmethacrylamide, diethylaminopropylmethacrylamide, 3-dimethylaminopropylacrylamide, 2-methacryloyloxyethyltrimethylammonium ethosulfate, 2-diethylaminoethyl methacrylate, 2-methacryloyloxyethyltrimethylammonium chloride, 3-methacryloylaminopropyltrimethylammonium chloride, 2-methacryloyloxyethyltrimethylammonium chloride, 2-acryloyloxyethyl-4-benzoyldimethylammonium bromide, 2-methacryloyloxyethyl-4-benzoyldimethylammonium bromide, allyltriphenylphosphonium bromide, allyltriphenylphosphonium chloride, 2-acrylamido-2-methyl-1-propanesulfonic acid, 2-diethylaninoethyl vinyl ether and/or 3-aminopropyl vinyl ether.

7. The antimicrobial film as claimed in one of claims 1 to 6, wherein the film has a thickness of 0.01-1.0 mm.

8. The use of the antimicrobial film as claimed in one of claims 1 to 7 as packaging film in the food sector.

9. The use of the antimicrobial film as claimed in one of claims 1 to 7 for lining or coating food packaging or food containers.

10. The apparatus for sterilizing liquid or pumpable foods comprising contact surfaces which are coated or lined with antimicrobial films as claimed in one of claims 1 to 7.

11. The apparatus as claimed in claim 10, wherein the contact surfaces are constructed as pipes, tubes, mixers, sieves, holders, container surfaces, machine parts.
